(19) United States
(12) Patent Application Publication
(10) Pub. No.: US 2006/0138738 A1
(43) Pub. Date: Jun. 29, 2006

(54) Canoe buddy

(76) Inventor: Scott Francis McKenna, Durand, IL (US)

Correspondence Address: Scott F. McKenna, 13331 Holverson Rd., Durand, IL, 61024, US

(21) Appl. No.: 10/230,665

(22) Filed: Aug. 29, 2002

(51) Int. Cl. B62B 1/00

(52) U.S. Cl. 280/47.131

(57) ABSTRACT

A canoe transportation system which is lightweight and easy to operate by one person. The user can easily move the canoe and its contents across the terrain without excessive effort or without causing damage to the underside of the canoe. Thus the CANOE BUDDY is a considerably easier method to move a canoe and its contents over the terrain.

### CROSS REFERENCE TO RELATED APPLICATIONS

This application is entitled to the benefit of Provisional Patent Application Ser. No. 60/315504, filed 2001, Aug. 29.

### BACKGROUND

This invention relates to canoes, specifically to moving the canoe easily over the terrain by one person.

### Description of Prior Art

Originally canoe transportation systems were difficult to manage by one person. The collapsible cart in U.S. Pat. No. 6,164,671 to Dailey, III (2000) or the watercraft carrier in U.S. Pat. No. 6,095,599 to Lambert (2000), are difficult for one person to operate and are cumbersome. These inventors failed to provide the user with a lightweight, easy to use system to move the canoe across the terrain.

### SUMMARY

The invention, an improved canoe transportation system is lightweight and easy for one person to use. The frame is made of lightweight aluminum with two wheels at the base. It easily slides onto either end of the canoe, and fastens simply with a pin.

### OBJECTS AND ADVANTAGES

Accordingly several objects and advantages of the invention are:

(a) to provide one person with the ease of moving the canoe across terrain;

(b) to move the canoe in such a way that no damage occurs to the underside of the canoe;

(c) to provide the person with the simplest, easiest and most convenient way to move the canoe from one place to another Further objects and advantages are to provide a transportation system which can be used easily and conveniently to move the canoe about without causing any damage to the canoe or undue stress upon the user.

### DRAWINGS FIGURES

FIG. 1 is a perspective view of the CANOE BUDDY constructed in accordance with the invention, showing the top of the CANOE BUDDY.

FIG. 2 is a perspective frontal view of the CANOE BUDDY of FIG. 1.

FIG. 2A is a perspective frontal view of the CANOE BUDDY with parts location of FIG. 1.

FIG. 3 is a perspective left sided view of the CANOE BUDDY of FIG. 1.

FIG. 4 is a perspective rear view of the CANOE BUDDY of FIG. 1.

FIG. 5 is a perspective right sided view of the CANOE BUDDY of FIG. 1.

FIG. 5A is a perspective right sided view of the CANOE BUDDY with parts location of FIG. 1.

### DESCRIPTION

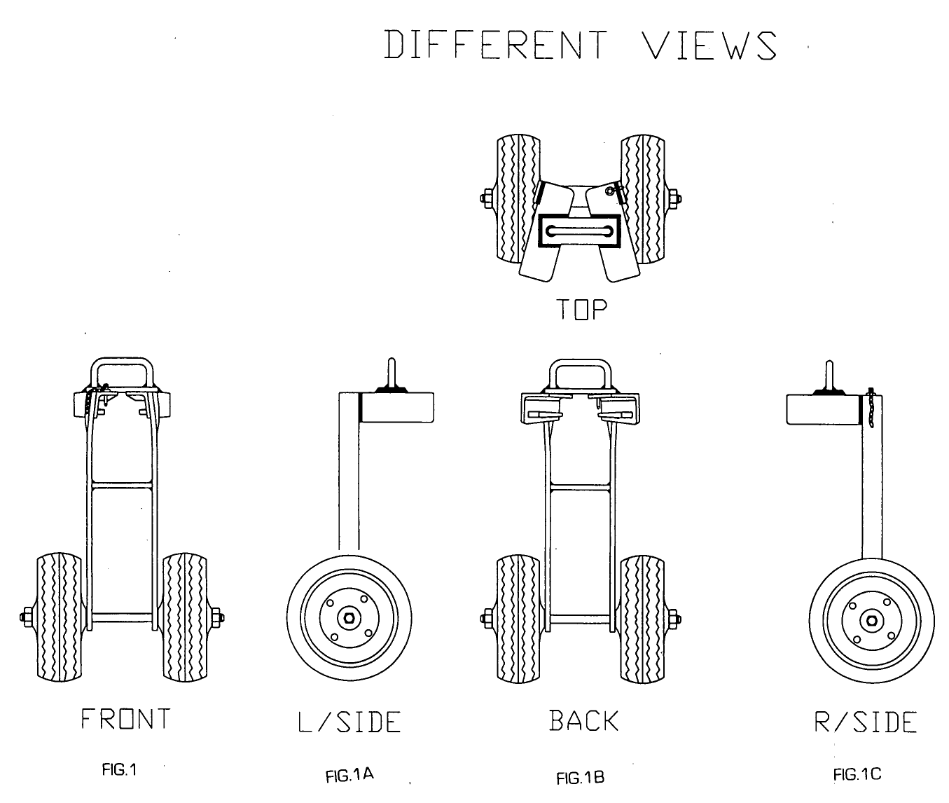

FIG. 1 is a perspective view taken from the user's top view of the CANOE BUDDY constructed in accordance with the invention.

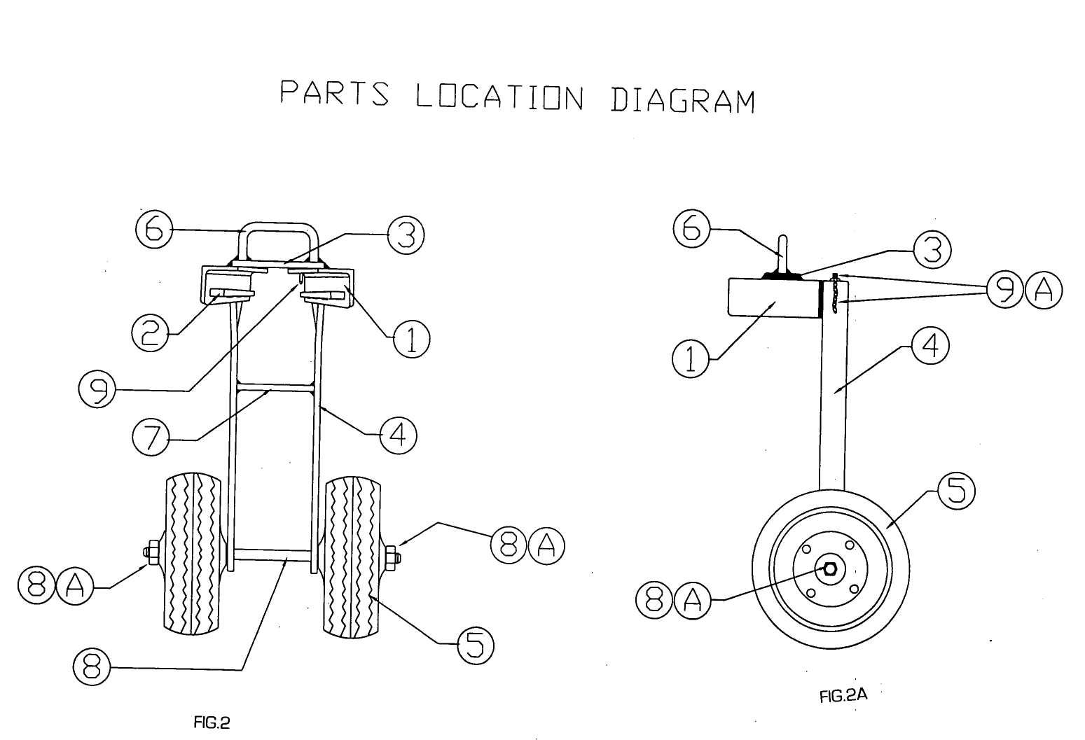

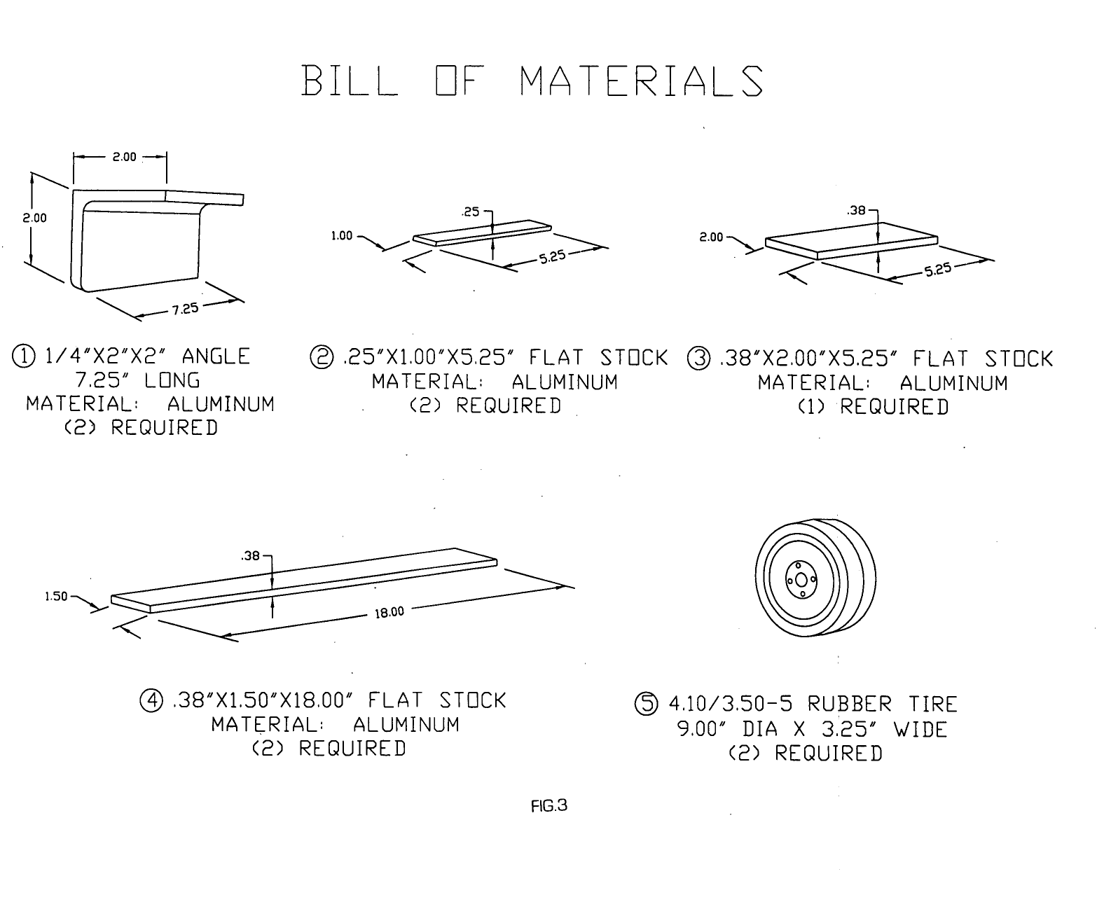

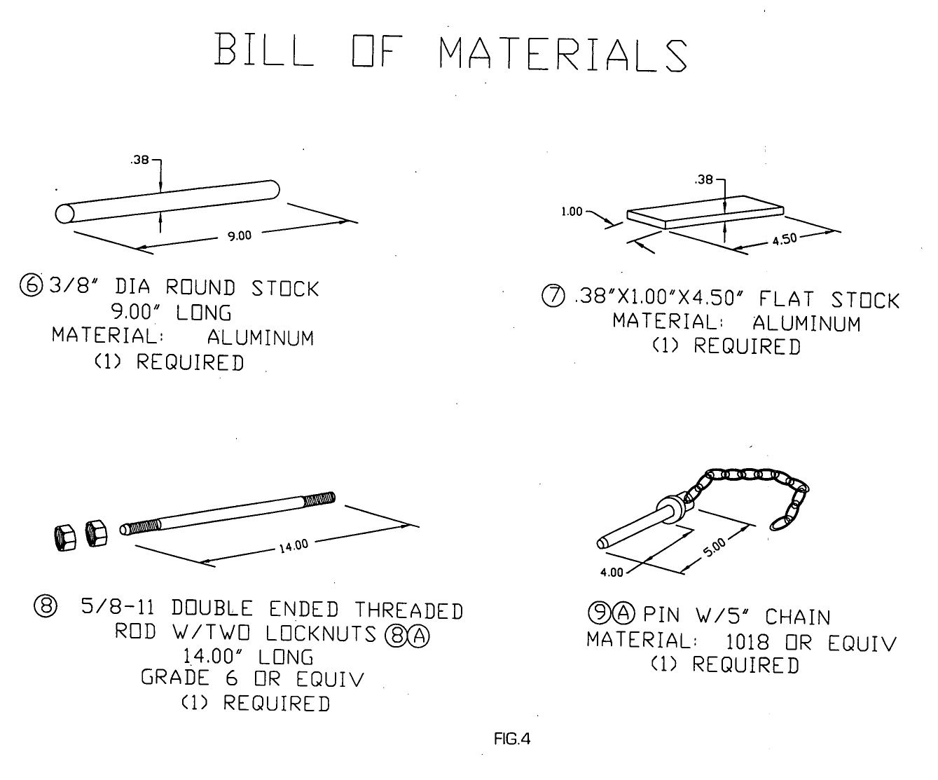

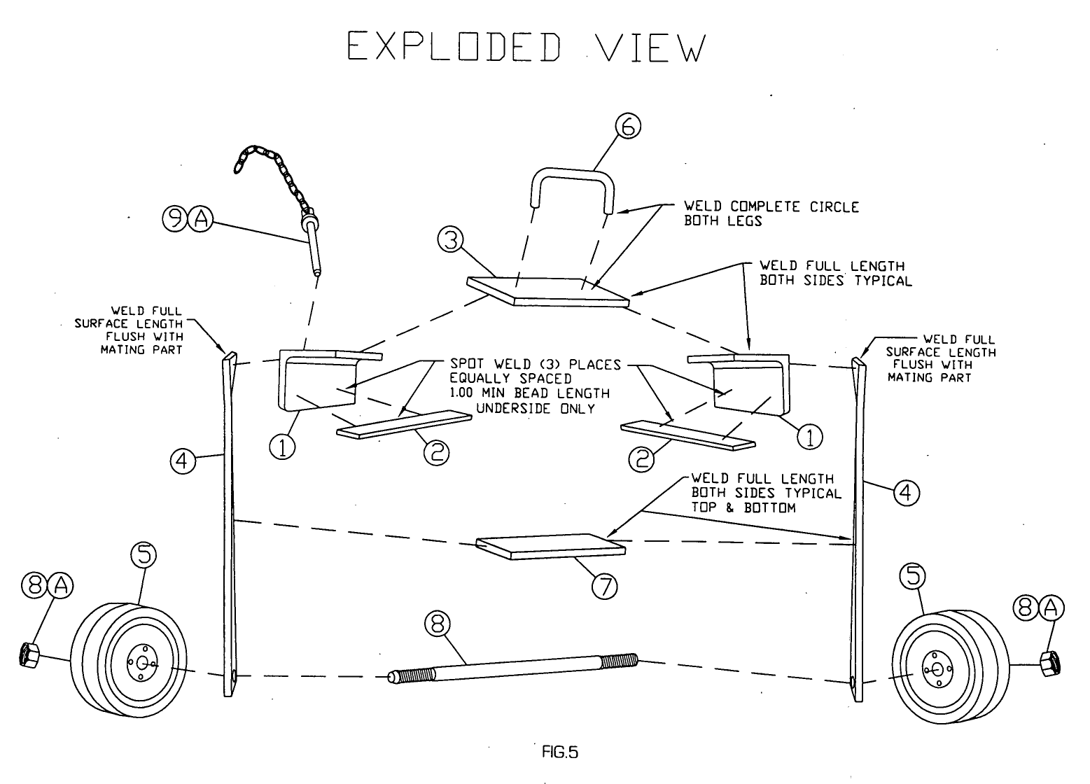

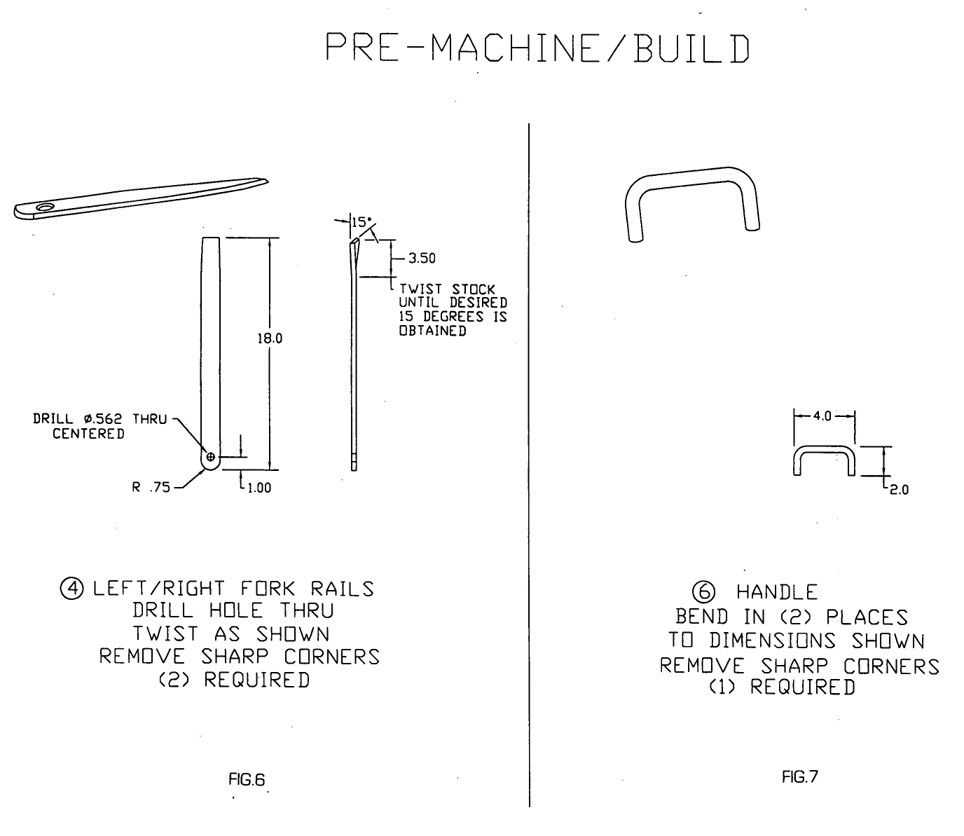

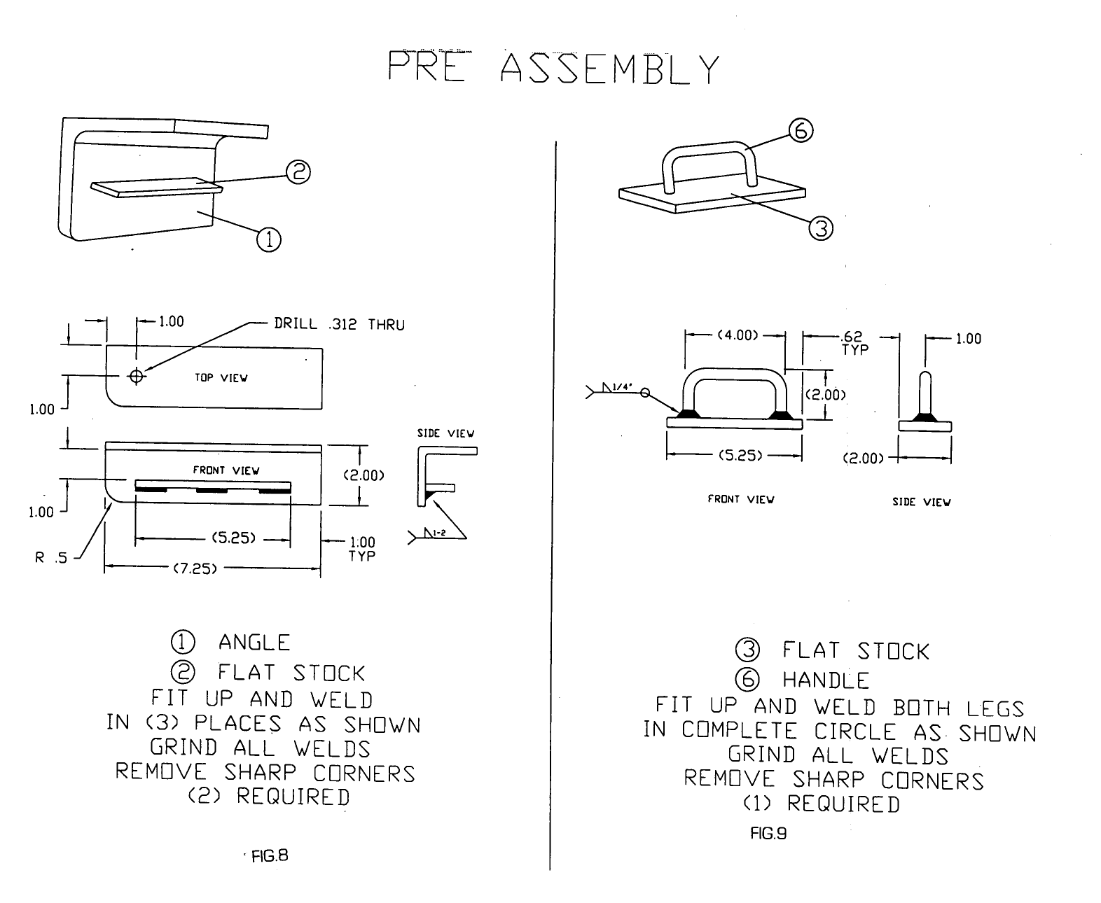

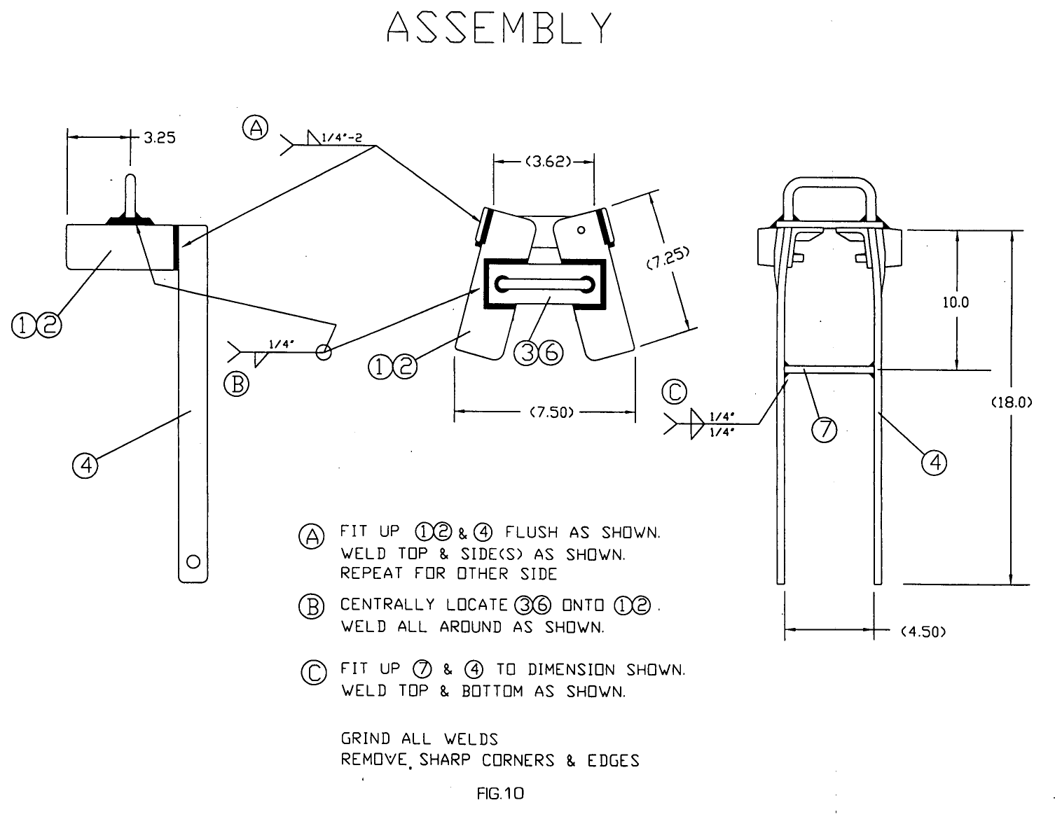

FIG. 2 is a prospective view taken from the user's front view.

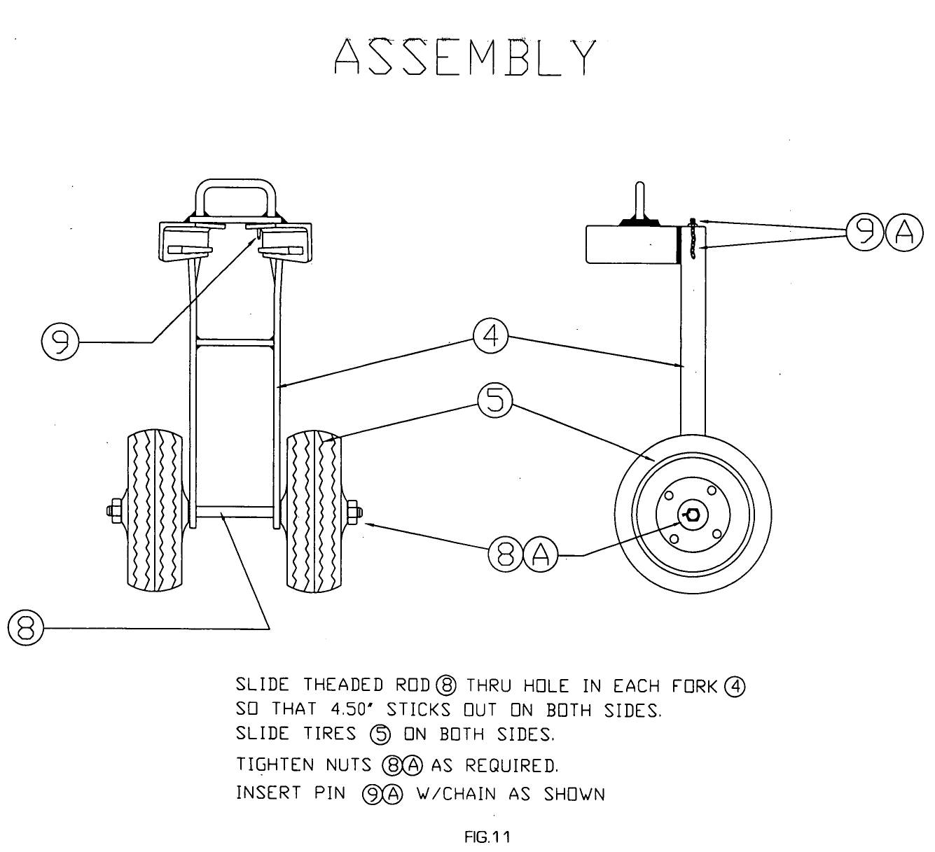

FIG. 2A and FIG. 5A is a perspective view taken from the user's front view and a perspective right sided view, respectively. No. 1 is ¼ in×2 in×2 in angle, 7.25 in long made of aluminum. No. 2 is 0.25 in×1 in×5.25 in flat stock aluminum No. 3 is 0.38 in×2 in×5.25 in flat stock aluminum No. 4 is 0.38 in×1.50 in×18 in flat stock aluminum. No. 5 is 4.10/3.50-5 rubber tire 9 in dia.×3.25 in. wide. No. 6 is ⅜ in dia. round stock 9 in long aluminum. No. 7 is 0.38 in×1 in×4.50 in flat stock aluminum No. 8 is ⅝ inch—11 double ended threaded rod with 2 locknuts. No. 8 A is 14 in long grade 6 or equivalent—1 required. No. 9 and 9A W/5 in chain material: 1018 or equivalent—1 required.

Operation

In operation one uses the CANOE BUDDY by sliding it onto either end of the canoe and fastening it with the pin. The user can then easily move the canoe across the terrain with the lightweight, wheeled device. Once the user has put the oppisite end into the water, the pin is unfastened and the CANOE BUDDY is removed. The CANOE BUDDY can then be placed into the canoe for later use. Moving the canoe with the CANOE BUDDY will not result in any damage to the underside of the Canoe.

### CONCLUSION, RAMIFICATIONS, AND SCOPE

Thus the reader will see that the CANOE BUDDY provides a highly reliable, lightweight yet easy to use system enabling one person to move a canoe across terrain easily and without causing damage to the underside of the canoe.

While my above description contains many specificities, these should not be construed as limitations on the scope of this invention, but rather as an exemplification of one preferred embodiment thereof Many other variations are possible. For example, the Canoe BUDDY could be adapted to fit models other than Coleman.

Thus the scope of the invention should be determined by the appended claims and their legal equivalents, rather than by the examples given.

1. A lightweight, easy to use canoe transportation system comprising an aluminum body with 2 wheels.

2. Can easily be operated by one person.

3. Enables the user to move the canoe across the terrain easily.

4. Prevents damage to the underside of the canoe caused by having to drag it or from use of other systems.
